(19) United States
(12) Patent Application Publication
(10) Pub. No.: US 2024/0430022 A1
(43) Pub. Date: Dec. 26, 2024

(54) RADIO COMMUNICATION CONTROL METHOD AND RADIO COMMUNICATION APPARATUS

(71) Applicant: Mitsubishi Electric Corporation, Chiyoda-ku, Tokyo (JP)

(72) Inventors: Hirofumi OGURA, Tokyo (JP); Toyohisa TANAKA, Tokyo (JP); Taiki TAGUCHI, Tokyo (JP); Daiki YAMAGUCHI, Tokyo (JP); Atsushi MORI, Tokyo (JP)

(21) Appl. No.: 18/704,381

(22) PCT Filed: Nov. 11, 2021
(86) PCT No.: PCT/JP2021/041499

§ 371 Date: Apr. 24, 2024

(51) Int. Cl. H04B 17/318; H04L 5/00

(52) U.S. Cl. CPC H04B 17/318; H04L 5/0048

(57) ABSTRACT

The object of the present disclosure is to provide a radio communication control method and a radio communication apparatus which allow efficient avoidance of the influence of noise. The radio communication control method according to the present disclosure includes: a first process of obtaining a received field strength of a preamble signal received through radio communication; a second process of calculating a receiving sensitivity estimated value as an estimated value of a receiving sensitivity, based on a radio frequency used in the radio communication and an amount of receiving sensitivity degradation as an amount of degradation in the receiving sensitivity which is caused by an operation of at least one interface; and a third process of controlling the operation of the at least one interface being activated, based on the received field strength obtained in the first process and the receiving sensitivity estimated value calculated in the second process.

### TECHNICAL FIELD

The present disclosure relates to a radio communication control method and a radio communication apparatus.

### BACKGROUND ART

Conventionally disclosed are radio communication devices in each of which deactivating an operation of a control unit according to a receiving operation of a receiving unit can avoid the influence of noise generated from the control unit during the operation of the receiving unit and maintain a better receiving sensitivity (for example, see Patent Document 1).

### PRIOR ART DOCUMENT

### Patent Document

Patent Document 1: Japanese Patent Application Laid-Open No. 2001-332994

### SUMMARY

### Problem to be Solved by the Invention

The radio communication device disclosed in Patent Document 1 adopts a time-division multiple access (TDMA) method which deactivates a part of operations of a control unit as a noise radiation source, according to a TDMA receiving slot. This causes a problem in that the radio communication device is inapplicable to another multiple access method. Examples of the other multiple access method include a code-division multiple access (CDMA) method, a frequency-division multiple access (FDMA) method, and a carrier-sense multiple access with collision avoidance (CSMA/CA) method.

Moreover, the radio communication device disclosed in Patent Document 1 deactivates operations of an LCD driver and an I/O control unit which are not directly necessary for radio communication, in the operations of the control unit as the noise radiation source. Thus, the radio communication device has a problem of deactivating operations of the control unit which are free from the influence of noise caused by the receiving operations of the radio communication.

The present disclosure has been conceived to solve such problems, and the object is to provide a radio communication control method and a radio communication device which allow efficient avoidance of the influence of noise.

### Means to Solve the Problem

To solve the problems, a radio communication control method according to the present disclosure includes: a first process of obtaining a received field strength of a preamble signal received through radio communication; a second process of calculating a receiving sensitivity estimated value, based on an amount of receiving sensitivity degradation and a radio frequency to be used in the radio communication, the receiving sensitivity estimated value being an estimated value of a receiving sensitivity, the amount of receiving sensitivity degradation being an amount of degradation in the receiving sensitivity, the degradation being caused by an operation of at least one interface; and a third process of controlling the operation of the at least one interface being activated, based on the received field strength obtained in the first process and the receiving sensitivity estimated value calculated in the second process.

### Effects of the Invention

Since the present disclosure controls an operation of an interface being activated, based on a received field strength and a receiving sensitivity estimated value, the influence of noise can be efficiently avoided.

The object, features, aspects, and advantages of the present disclosure will become more apparent from the following detailed description and the accompanying drawings of the present disclosure.

### BRIEF DESCRIPTION OF DRAWINGS

FIG. 1 is a block diagram illustrating an example configuration of a radio communication apparatus according to the first embodiment.

FIG. 2 is a timing chart illustrating control operations on an interface when the radio communication apparatus performs radio communication according to the first embodiment.

FIG. 3 illustrates an example amount of receiving sensitivity degradation of a radio unit when an interface is activated according to the first embodiment.

FIG. 4 illustrates an example amount of receiving sensitivity degradation of the radio unit when an interface is activated according to the first embodiment.

FIG. 5 is a flowchart illustrating example operations of the radio communication apparatus according to the first embodiment.

FIG. 6 is a flowchart illustrating example operations of the radio communication apparatus according to the second modification of the first embodiment.

FIG. 7 is a timing chart illustrating control operations on an interface when the radio communication apparatus performs radio communication according to the fourth modification of the first embodiment.

FIG. 8 is a timing chart illustrating control operations on an interface when the radio communication apparatus performs radio communication according to the second embodiment.

FIG. 9 illustrates an example method of controlling interfaces according to an RSSI class according to the second embodiment.

FIG. 10 is a timing chart illustrating control operations on an interface when the radio communication apparatus performs radio communication according to the second modification of the second embodiment.

FIG. 11 illustrates an example hardware configuration of the radio communication apparatus according to the first embodiment.

FIG. 12 illustrates an example hardware configuration of the radio communication apparatus according to the first embodiment.

### DESCRIPTION OF EMBODIMENTS

### The First Embodiment

### [Configuration]

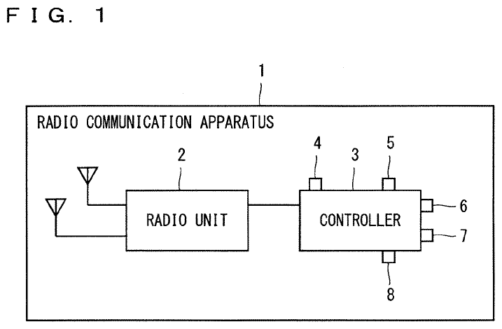

FIG. 1 is a block diagram illustrating an example configuration of a radio communication apparatus 1 according to the first embodiment.

The radio communication apparatus 1 includes a radio unit 2 and a controller 3. The radio unit 2 includes antennas, and performs radio communication with an external radio communication device. FIG. 1 illustrates two antennas that are a transmission antenna and a receiving antenna. Thus, the radio communication apparatus 1 includes the radio unit 2, and performs radio communication with the external radio communication device through the radio unit 2.

The controller 3 is wired connected to the radio unit 2, and performs wired communication with the radio unit 2. The controller 3 includes a central processing unit (CPU) for control that is not illustrated, and a plurality of interfaces 4, 5, 6, 7, and 8 (may be hereinafter referred to as “interfaces 4 to 8”) that are connected to external instruments. The CPU for control controls activation and deactivation of each of the interfaces 4 to 8.

### [Operations]

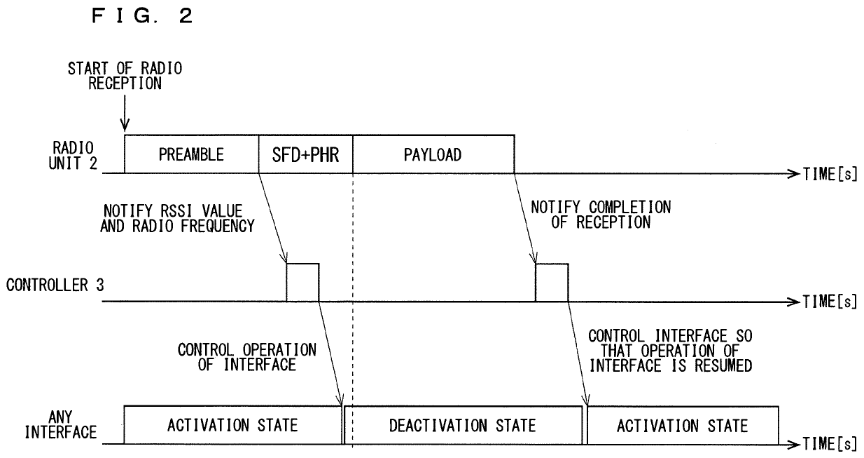

FIG. 2 is a timing chart illustrating control operations on an interface when the radio communication apparatus 1 performs radio communication.

In FIG. 2, “START OF RADIO RECEPTION” indicates the timing to receive data by the radio unit 2 from an external radio communication device. The data to be received by the radio unit 2 from the external radio communication device consists of “PREAMBLE”, “SFD+PHR”, and “PAYLOAD”.

“PREAMBLE” is a signal for synchronization and a bit string of a predetermined pattern, and is added to a header of a data body. Upon receipt of a preamble, the radio unit 2 recognizes coming transmission of data from an external radio communication device. Hereinafter, “PREAMBLE” will also be referred to as a preamble signal.

“SFD+PHR” consists of a start of frame delimiter (SFD) and a PHY header (PHR), and includes information on, for example, a preamble length and a data format. The radio unit 2 uses “SFD+PHR” for handling data to be received.

“PAYLOAD” is the data body to be received by the radio unit 2 from the external radio communication device which excludes a header and address information. Hereinafter, “PAYLOAD” will also be referred to as a payload signal.

The radio unit 2 measures a received signal strength indicator (RSSI) value that is a received field strength (received power) of the preamble signal received from the external radio communication device. After completion of receiving the preamble signal, the radio unit 2 notifies, through wired communication, the controller 3 of the RSSI value of the measured preamble signal and a radio frequency at which the radio unit 2 performs radio communication with the external radio communication device.

The controller 3 determines an interface whose operation is to be deactivated from among the interfaces 4 to 8, based on the RSSI value of the preamble signal and the radio frequency which have been notified from the radio unit 2, and the amounts of receiving sensitivity degradation of the radio unit 2 when the interfaces 4 to 8 are activated. Then, the controller 3 controls the determined interface so that the operation is deactivated.

The amounts of receiving sensitivity degradation of the radio unit 2 when the interfaces 4 to 8 are activated mean amounts of degradation at receiving sensitivity points of the radio unit 2 at any radio frequency. The degradation are caused by noise generated when the interfaces 4 to 8 are activated.

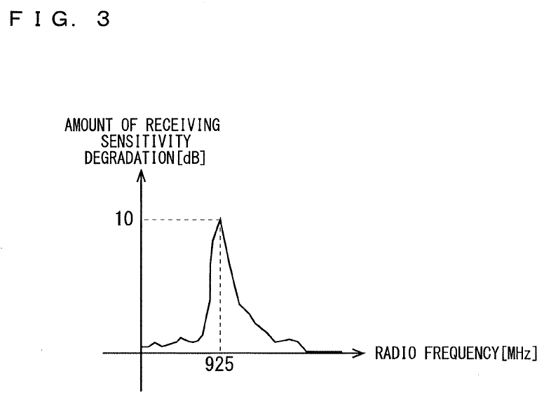

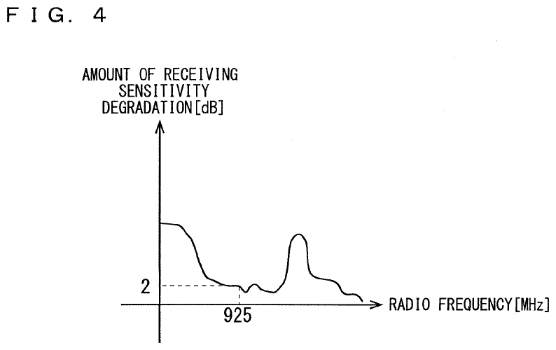

FIGS. 3 and 4 illustrate example amounts of receiving sensitivity degradation when the interfaces 4 to 8 are activated. In FIGS. 3 and 4, the vertical axis represents the amount of receiving sensitivity degradation [dB], and the horizontal axis represents the radio frequency [MHz]. The controller 3 holds information on the amounts of receiving sensitivity degradation of the radio unit 2 when the interfaces 4 to 8 are activated as illustrated in FIGS. 3 and 4, in advance before start of operations of the radio communication apparatus 1.

FIG. 3 illustrates a relationship between the radio frequency and the amount of receiving sensitivity degradation of the radio unit 2 when the interface 4 is activated. The values in FIG. 3 are examples. It is assumed that the interface 4 includes an integrated circuit (IC) that operates with a 25 MHz clock. The example of FIG. 3 illustrates that the largest noise is radiated at 925 MHz that is a frequency of multiples of 25 MHZ. As illustrated in FIG. 3, when the radio frequency is 925 MHZ, the amount of receiving sensitivity degradation of the radio unit 2 is 10 dB.

FIG. 4 illustrates a relationship between the radio frequency and the amount of receiving sensitivity degradation of the radio unit 2 when the interface 7 is activated. The values in FIG. 4 are examples. The example of FIG. 4 assumes that larger noise is generated at radio frequencies except 925 MHz than that at the radio frequency of 925 MHz when the interface 7 is activated. As illustrated in FIG. 4, when the radio frequency is 925 MHz, the amount of receiving sensitivity degradation of the radio unit 2 is 2 dB.

As exemplified in FIGS. 3 and 4, the relationship between the radio frequency and the amount of receiving sensitivity degradation of the radio unit 2 differs for each type of the interfaces 4 to 8.

Referring back to the description on FIG. 2, the radio unit 2 that has completed receiving the payload signal notifies the controller 3 of the completion of the reception.

Upon receipt of the completion of the reception from the radio unit 2, the controller 3 controls the interface whose operation has been deactivated so that the operation of the interface is resumed.

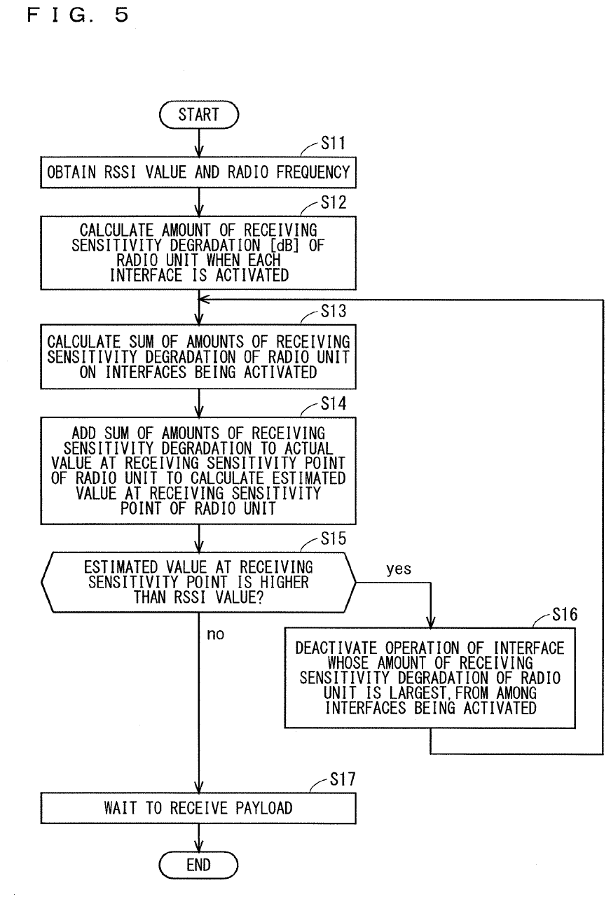

FIG. 5 is a flowchart illustrating example operations of the radio communication apparatus 1, specifically, operations of the controller 3 that controls operations of the interfaces 4 to 8.

In Step S11 (a first process), the controller 3 obtains the RSSI value and the radio frequency from the radio unit 2. Here, the RSSI value is an RSSI value of a preamble which has been received by the radio unit 2 from the external radio communication device. The lower the RSSI value is, the lower the level of the reception signal in the radio unit 2 is, which increases the probability of failing to receive the signal. Furthermore, the radio frequency is a radio frequency at which the radio unit 2 performs radio communication with the external radio communication device.

In Step S12, the controller 3 calculates the amount of receiving sensitivity degradation [dB] of the radio unit 2 when each of the interfaces 4 to 8 is activated. Specifically, the controller 3 calculates the amount of receiving sensitivity degradation [dB] of the radio unit 2 when each of the interfaces 4 to 8 is activated at the radio frequency obtained from the radio unit 2, based on information indicating the relationship between the radio frequency and the amount of receiving sensitivity degradation of the radio unit 2 which is held by the controller 3 itself. The interfaces for each of which the amount of receiving sensitivity degradation is to be calculated may be only interfaces that are currently being activated.

In Step S13, the controller 3 identifies the interfaces that are currently being activated, and calculates a sum of the amounts of receiving sensitivity degradation of the radio unit 2 on the interfaces being activated.

In Step S14 (a second process), the controller 3 adds the sum of the amounts of receiving sensitivity degradation calculated in Step S13 to an actual value at a receiving sensitivity point of the radio unit 2 (a receiving sensitivity actual value) to calculate an estimated value at the receiving sensitivity point of the radio unit 2 in a state where the interfaces are currently being activated. As the estimated value at the receiving sensitivity point is lower, a signal with a lower level can be received.

Here, the actual value at the receiving sensitivity point of the radio unit 2 is an actual value at a receiving sensitivity point of the radio unit 2 when none of the interfaces 4 to 8 is activated. The controller 3 holds, in advance, the actual value at the receiving sensitivity point of the radio unit 2.

In Step S15, the controller 3 compares the RSSI value obtained in Step S11 with the estimated value at the receiving sensitivity point which has been calculated in Step S14. When the estimated value of a receiving sensitivity is higher than the RSSI value as a result of the comparison, the process proceeds to Step S16. When the estimated value of the receiving sensitivity is lower than or equal to the RSSI value, the process proceeds to Step S17.

In Step S16 (a third process), the controller 3 deactivates the operation of the interface whose amount of receiving sensitivity degradation of the radio unit 2 is the largest, from among the interfaces being activated. Then, the process proceeds to Step S13.

For example, assume a case where the interfaces 4 and 7 are being activated, the radio frequency at which the radio unit 2 performs radio communication with an external radio communication device is 925 MHz, and the amounts of receiving sensitivity degradation of the radio unit 2 when the interface 4 and the interface 7 are activated are those indicated by the information of FIG. 3 and FIG. 4, respectively. In such a case, the controller 3 deactivates the operation of the interface 4 whose amount of receiving sensitivity degradation of the radio unit 2 is the largest.

When the estimated value at the receiving sensitivity point is lower than or equal to the RSSI value, it is estimated that reception of a signal will be successful. Thus, the radio unit 2 is set to a state of waiting to receive a payload signal in Step S17.

The aforementioned processes can minimize the number of interfaces whose operations are to be deactivated, and avoid the influence of noise.

### [Advantages]

As described above, the radio unit 2 notifies an RSSI value of a reception signal and a radio frequency between receipt of a preamble signal and receipt of a payload signal, and the controller 3 controls operations of the interfaces before starting to receive the payload signal in the first embodiment. Thus, radiated noise can be avoided upon receipt of the payload signal.

Furthermore, the radiated noise can be avoided, irrespective of the type of the multiple access method.

Furthermore, the radio unit 2 calculates an estimated value at the receiving sensitivity point of the radio unit 2 when the interfaces 4 to 8 are activated, based on the radio frequency at which the radio unit 2 performs radio communication with an external radio communication device, and determines an interface whose operation is to be deactivated from among the interfaces 4 to 8, based on the calculated estimated value of the receiving sensitivity and the RSSI value. The aforementioned processes can minimize the number of interfaces whose operations are to be deactivated, and maintain a state where the radio unit 2 can receive a signal.

### [The First Modification]

Described above is that the controller 3 holds information on the amounts of receiving sensitivity degradation in advance. The operation of the controller 3 is not limited to this. The controller 3 need not hold the information on the amounts of receiving sensitivity degradation in advance.

Specifically, after installing the radio communication apparatus 1 and before start of the operations of the radio communication apparatus 1, the radio unit 2 measures the amount of receiving sensitivity degradation when each of the interfaces 4 to 8 is activated, and notifies the controller 3 of information on the measured amounts of receiving sensitivity degradation. The controller 3 holds the information on the amounts of receiving sensitivity degradation which has been notified from the radio unit 2.

The radio unit 2 measures a receiving sensitivity point (a measurement receiving sensitivity value) corresponding to a varying radio frequency when each of the interfaces 4 to 8 is activated. Then, the radio unit 2 takes a difference between the value at the measured receiving sensitivity point and the actual value at the receiving sensitivity point of the radio unit 2 which corresponds to the radio frequency, so that the amount of receiving sensitivity degradation of the radio unit 2 when each of the interfaces 4 to 8 is activated under the installation environment of the radio communication apparatus 1 can be calculated (a fourth process). The actual value at the receiving sensitivity point of the radio unit 2 is determined based on prior tests for the receiving sensitivity point or from the specification of the radio communication apparatus 1. When the amount of receiving sensitivity degradation differs depending on an installation environment of the radio communication apparatus 1, a method of calculating the amount of receiving sensitivity degradation as described above is effective.

### [The Second Modification]

Described above is deactivating the operation of the interface whose amount of receiving sensitivity degradation of the radio unit 2 is the largest, from among the interfaces being activated. The operation is not limited to this.

The controller 3 may control interfaces so that operations of the interfaces are deactivated in order from an interface with a lower operating priority (hereinafter simply referred to as a “priority”).

Furthermore, the controller 3 may control the operations of the interfaces 4 to 8 in consideration of not only the priorities of the interfaces 4 to 8 but also the priority of the radio unit 2. Even when the significant influence of noise disables radio communication regardless of the operations of the interfaces, the operation of the interface with a higher priority can be continued.

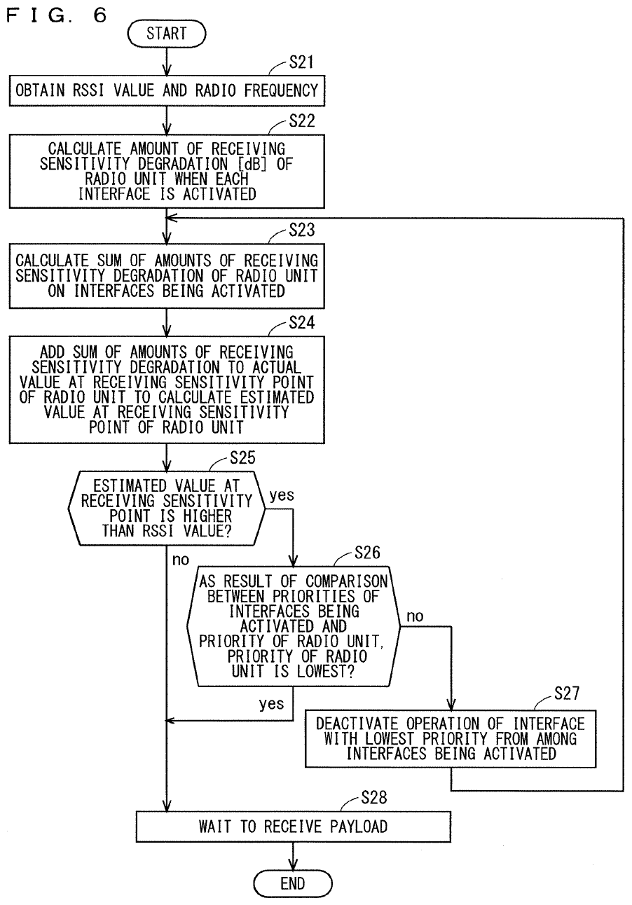

FIG. 6 is a flowchart illustrating example operations of the radio communication apparatus 1 according to the second modification. Since Steps S21 to S25 in FIG. 6 are the same as Steps S11 to S15 in FIG. 5, respectively, the description will be omitted herein. Thus, Steps S26 to S28 will be described hereinafter. The controller 3 holds, in advance, the priorities of the interfaces 4 to 8 and the priority of the radio unit 2.

In Step S26, the controller 3 compares priorities of interfaces being activated from among the interfaces 4 to 8, with the priority of the radio unit 2, and determines whether the priority of the radio unit 2 is the lowest. When the priority of the radio unit 2 is the lowest as a result of the determination, the process proceeds to Step S28. When the priority of the radio unit 2 is not the lowest, the process proceeds to Step S27.

In Step S27, the controller 3 controls an interface with the lowest priority from among the interfaces being activated so that the operation of the interface is deactivated. Then, the process proceeds to Step S23.

When the estimated value at the receiving sensitivity point is lower than or equal to the RSSI value, it is estimated that reception of a signal will be successful. Thus, the radio unit 2 is set to a state of waiting to receive a payload signal in Step S28. Even though the controller 3 determines that the estimated value at the receiving sensitivity point is higher than the RSSI value in Step S25, when the controller 3 determines that the priority of the radio unit 2 is the lowest in Step S26, the radio unit 2 is set to a state of waiting to receive a payload signal.

Thus, deactivating the operation of only the interface with a lower priority can maintain a state where the radio unit 2 can receive a signal.

### [The Third Modification]

Described above is that the controller 3 obtains the RSSI value and the radio frequency from the radio unit 2. The operation of the controller 3 is not limited to this.

When the radio frequency to be used for the radio communication between the radio unit 2 and the external radio communication device is known and is not changed, the controller 3 does not obtain any radio frequency from the radio unit 2 and uses the known radio frequency. Here, the controller 3 holds, in advance, information on the known radio frequency.

When the controller 3 cannot obtain an RSSI value from the radio unit 2, the controller 3 converts, into an RSSI value, for example, a bit error rate (BER) or a packet error rate (PER) calculated based on the past reception data received by the radio unit 2. Since the conversion of the bit error rate or the packet error rate into the RSSI value is performed based on the error rate performance, the bit error rate or the packet error rate needs to be converted in accordance with a modulating method.

### [The Fourth Modification]

Described above is that the radio unit 2 notifies the controller 3 of an RSSI value and a radio frequency immediately after completion of receiving a preamble signal as illustrated in FIG. 2. The notification is not limited to this.

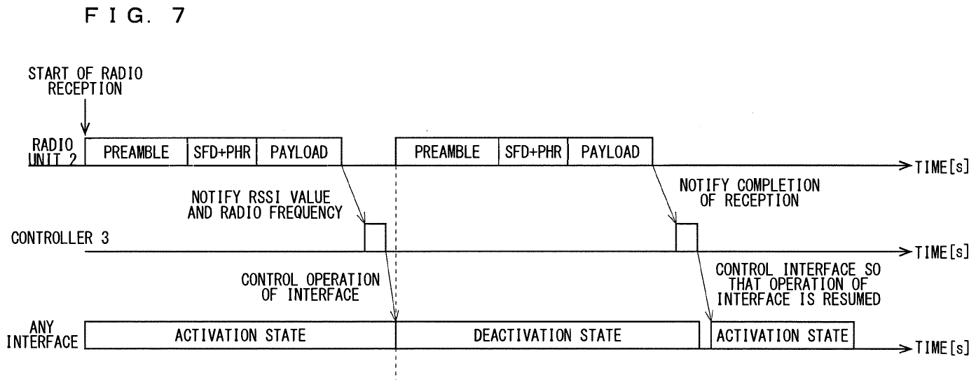

FIG. 7 is a timing chart illustrating control operations on an interface when the radio communication apparatus 1 according to the fourth modification performs radio communication. As illustrated in FIG. 7, the radio unit 2 may notify the controller 3 of an RSSI value and a radio frequency immediately after completion of receiving a payload signal. This is effective for the radio unit 2 that cannot be controlled immediately after completion of receiving a preamble signal. Thus, the radio unit 2 can avoid the influence of noise on a signal to be received next.

### [The Fifth Modification]

Described above is the controller 3 including the five interfaces 4 to 8 as illustrated in FIG. 1. The controller 3 is not limited to this. The controller 3 may include a single interface or a plurality of interfaces.

### The Second Embodiment

The first embodiment describes that the radio unit 2 notifies the controller 3 of the RSSI value of the received preamble signal and a radio frequency at which the radio unit 2 performs radio communication with an external radio communication device and that the controller 3 determines an interface whose operation is to be deactivated, based on the RSSI value and the radio frequency that have been notified. The second embodiment will describe that the radio unit 2 notifies the controller 3 of class information on an RSSI value (hereinafter referred to as an “RSSI class (a received field strength class)”) instead of the RSSI value and the radio frequency and that the controller 3 determines an interface whose operation is to be deactivated, based on the notified RSSI class.

A radio communication device according to the second embodiment is identical to the radio communication apparatus 1 (see FIG. 1) according to the first embodiment. Thus, the following will be described assuming that the radio communication device according to the second embodiment is the radio communication apparatus 1 in FIG. 1.

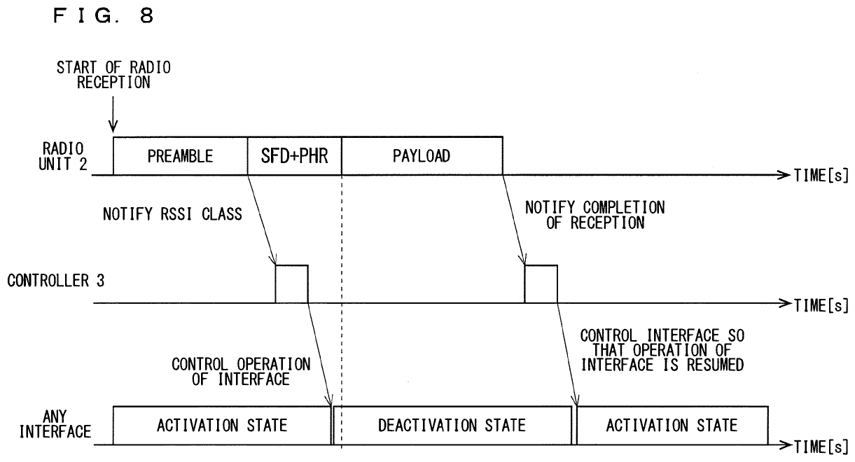

FIG. 8 is a timing chart illustrating control operations on an interface when the radio communication apparatus 1 according to the second embodiment performs radio communication.

The radio unit 2 measures an RSSI value that is a received field strength (received power) of the preamble signal received from the external radio communication device. After completion of receiving the preamble signal, the radio unit 2 determines an RSSI class from the RSSI value of the measured preamble signal (the second process), and notifies the controller 3 of the determined RSSI class.

The controller 3 determines whether to deactivate an operation of an interface, based on the RSSI class notified from the radio unit 2 (the first and second processes). The method of determining the interface whose operation is to be deactivated is identical to that according to the first embodiment.

For example, the controller 3 may calculate the amount of receiving sensitivity degradation (the third process) similarly to the first embodiment, and control an interface whose amount of receiving sensitivity degradation is the largest so that an operation of the interface is deactivated (the second process).

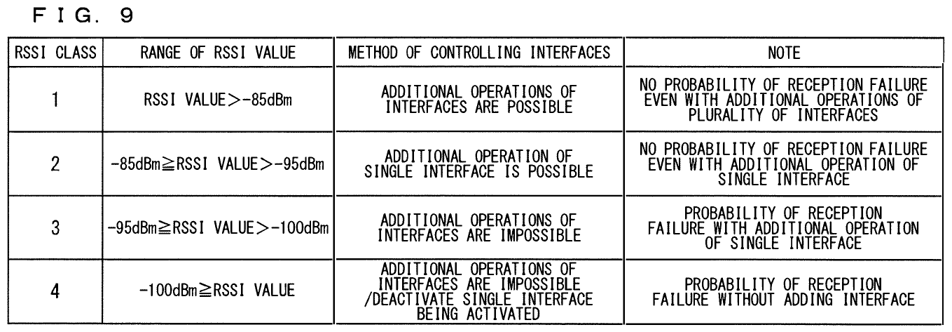

FIG. 9 illustrates an example method of controlling interfaces according to an RSSI class according to the second embodiment. The RSSI class is determined in consideration of the environment in which the radio communication apparatus 1 is used, preliminary studies, and past operation performance. In the example of FIG. 9, only when the RSSI class is “4”, an interface to be deactivated is determined from among the interfaces being activated.

### [Advantages]

Since the radio unit 2 according to the second embodiment notifies only the RSSI class, the data amount to be notified from the radio unit 2 to the controller 3 can be less than that according to the first embodiment. Thus, the processing time can be shortened. Information on the RSSI class in the second embodiment consists of 2 bits.

Furthermore, since a method of controlling interfaces is determined for each of the RSSI classes, the number of interfaces whose operations are to be deactivated can be minimized, and a state where the radio unit 2 can receive a signal can be maintained.

### [The First Modification]

Described above is the RSSI classes of four types as illustrated in FIG. 9. The RSSI classes are not limited to these.

An RSSI class of any type may be defined according to a transmission rate of wired communication from the radio unit 2 to the controller 3 or the method of controlling interfaces.

### [The Second Modification]

Described above is that the radio unit 2 notifies the controller 3 of an RSSI class immediately after completion of receiving a preamble signal as illustrated in FIG. 8. The notification is not limited to this.

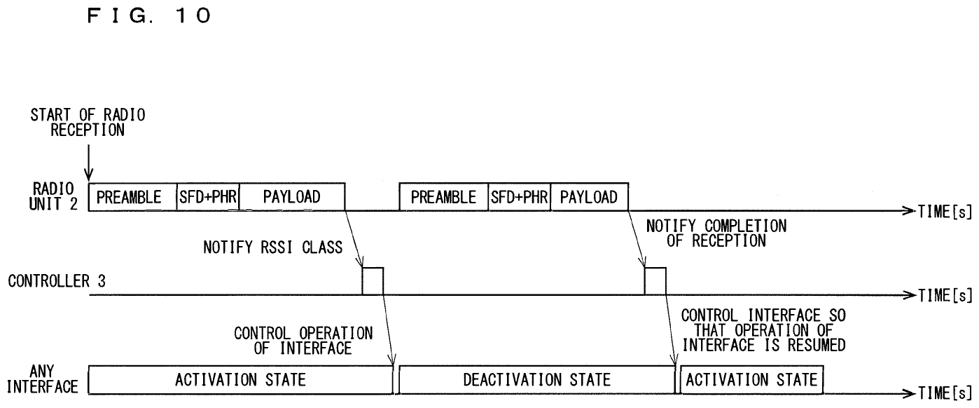

FIG. 10 is a timing chart illustrating control operations on an interface when the radio communication apparatus 1 according to the second modification performs radio communication. As illustrated in FIG. 10, the radio unit 2 may notify the controller 3 of an RSSI class immediately after completion of receiving a payload signal. This is effective for the radio unit 2 that cannot be controlled immediately after completion of receiving a preamble signal. Thus, the radio unit 2 can avoid the influence of noise on a signal to be received next.

### [The Third Modification]

The controller 3 may determine whether to deactivate operations of the interfaces, based on the RSSI class, calculate an estimated value at the receiving sensitivity point of the radio unit 2 which corresponds to the radio frequency similarly to the first embodiment, and determine an interface whose operation is to be deactivated, based on the calculated estimated value at the receiving sensitivity point. Here, the controller 3 may obtain the radio frequency from the radio unit 2, or hold a known radio frequency in advance.

### [Hardware Configuration]

Functions of the radio unit 2 and the controller 3 in the radio communication apparatus 1 illustrated in FIG. 1 can be performed by a processing circuit. In other words, the radio communication apparatus 1 includes the processing circuit for performing radio communication with an external radio communication device and controlling operations of interfaces. The processing circuit may be dedicated hardware or a processor (also referred to as a CPU, a central processing unit, a processing unit, an arithmetic unit, a microprocessor, a microcomputer, or a digital signal processor (DSP)) that executes a program stored in a memory.

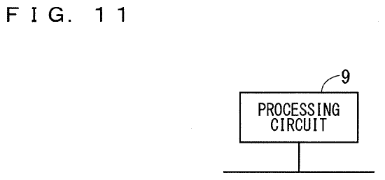

When the processing circuit is dedicated hardware, a processing circuit 9 corresponds to, for example, a single circuit, a composite circuit, a programmed processor, a parallel-programmed processor, an application-specific integrated circuit (ASIC), a field-programmable gate array (FPGA), or any combination of these as illustrated in FIG. 11. Each of the functions of the radio unit 2 and the controller 3 may be performed by the processing circuit 9, or the functions may be collectively performed by the single processing circuit 9.

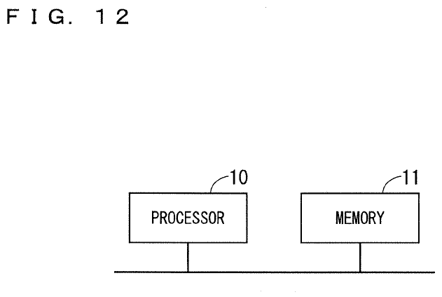

When the processing circuit 9 is a processor 10 in FIG. 12, each of the functions of the radio unit 2 and the controller 3 is performed by software, firmware, or a combination of the software and the firmware. The software or the firmware is described as a program, and stored in a memory 11. The processor 10 performs the functions by reading and executing the program stored in the memory 11. In other words, the radio communication apparatus 1 includes the memory 11 for storing programs which consequently execute the steps of performing radio communication with an external radio communication device and controlling an operation of an interface. These programs cause a computer to execute procedures or methods of the radio unit 2 and the controller 3. Here, examples of the memory may include non-volatile or volatile semiconductor memories such as a random access memory (RAM), a read-only memory (ROM), a flash memory, an erasable programmable read-only memory (EPROM), an electrically erasable programmable read-only memory (EEPROM), a magnetic disc, a flexible disk, an optical disk, a compact disk, a digital versatile disc (DVD), and further any storage medium to be used in the future.

A part of the functions of the radio unit 2 and the controller 3 may be performed by dedicated hardware, and the other functions may be performed by software or firmware.

Consequently, the processing circuit can perform the functions by hardware, software, firmware, or any combinations of these.

The embodiments can be freely combined and appropriately modified or omitted, within the scope of the present disclosure.

While the present disclosure is described in detail, the foregoing description is in all aspects illustrative and is not restrictive. Therefore, numerous modifications and variations that have not yet been exemplified can be devised.

### EXPLANATION OF REFERENCE SIGNS

1 radio communication apparatus, 2 radio unit, 3 controller, 4, 5, 6, 7, 8 interface, 9 processing circuit, 10 processor, 11 memory.

1. A radio communication control method, comprising:
a first process of obtaining a received field strength of a preamble signal received through radio communication;
a second process of calculating a receiving sensitivity estimated value, based on an amount of receiving sensitivity degradation and a radio frequency to be used in the radio communication, the receiving sensitivity estimated value being an estimated value of a receiving sensitivity, the amount of receiving sensitivity degradation being an amount of degradation in the receiving sensitivity, the degradation being caused by an operation of at least one interface; and
a third process of controlling the operation of the at least one interface being activated, based on the received field strength obtained in the first process and the receiving sensitivity estimated value calculated in the second process.

2. The radio communication control method according to claim 1,
wherein the third process includes deactivating an operation of an interface whose amount of receiving sensitivity degradation is largest when the receiving sensitivity estimated value is higher than the received field strength, the interface being included in the at least one interface being activated.

3. The radio communication control method according to claim 1,
wherein the third process includes deactivating an operation of an interface whose priority is lowest when the receiving sensitivity estimated value is higher than the received field strength, the interface being included in the at least one interface being activated.

4. The radio communication control method according to claim 1,
wherein the first process includes obtaining the radio frequency to be used in the radio communication, and
the second process includes calculating the receiving sensitivity estimated value, based on the radio frequency obtained in the first process and the amount of receiving sensitivity degradation held in advance.

5. The radio communication control method according to claim 1, comprising
a fourth process of calculating the amount of receiving sensitivity degradation based on a difference between a measurement receiving sensitivity value and a receiving sensitivity actual value before the first process, the measurement receiving sensitivity value indicating a receiving sensitivity measured at a varying radio frequency when the at least one interface is activated, the receiving sensitivity actual value indicating a receiving sensitivity corresponding to the radio frequency when the at least one interface is not activated.

6. The radio communication control method according to claim 1,
wherein the first process includes estimating the received field strength based on a bit error rate or a packet error rate of the preamble signal received in the first process after a payload signal is received.

7. The radio communication control method according to claim 1,
wherein the third process is executed after completion of receiving a payload signal.

8. (canceled)

9. (canceled)

10. (canceled)

11. A radio communication apparatus, comprising:
at least one interface connected to an external instrument;
a processor to execute a program; and
a memory to store the program which, when executed by the processor, performs processes of:
performing radio communication with an external radio communication device;
receiving a received field strength of a preamble signal from the external radio communication device;
calculating a receiving sensitivity estimated value, based on an amount of receiving sensitivity degradation and a radio frequency to be used in the radio communication, and controlling an operation of the at least one interface being activated, based on the received field strength and the receiving sensitivity estimated value, the receiving sensitivity estimated value being an estimated value of a receiving sensitivity, the amount of receiving sensitivity degradation being an amount of degradation in a receiving sensitivity, the degradation being caused by the operation of the at least one interface.

12. The radio communication apparatus according to claim 11,
wherein the processes comprise deactivating an operation of an interface whose amount of receiving sensitivity degradation is largest when the receiving sensitivity estimated value is higher than the received field strength, the interface being included in the at least one interface being activated.

13. The radio communication apparatus according to claim 11,
wherein the processes comprise deactivating an operation of an interface whose priority is lowest when the receiving sensitivity estimated value is higher than the received field strength, the interface being included in the at least one interface being activated.

14. The radio communication apparatus according to claim 11,
wherein the processes comprise:
obtaining, from the external radio communication device, the radio frequency to be used in the radio communication; and
calculating the receiving sensitivity estimated value, based on the radio frequency obtained and the amount of receiving sensitivity degradation held in advance.

15. The radio communication apparatus according to claim 11,
wherein before the radio communication apparatus is operated, the processes comprise:
measuring a measurement receiving sensitivity value indicating a receiving sensitivity at a varying radio frequency when the at least one interface is activated; and
calculating the amount of receiving sensitivity degradation based on a difference between the measurement receiving sensitivity value measured and a receiving sensitivity actual value indicating a receiving sensitivity corresponding to the radio frequency when the at least one interface is not activated.

16. The radio communication apparatus according to claim 11,
wherein the processes comprise:
obtaining a bit error rate or a packet error rate of a signal received from the external radio communication device; and
estimating the received field strength based on the bit error rate or the packet error rate.

17. The radio communication apparatus according to claim 16,
wherein the signal received from the external radio communication device is the preamble signal or a payload signal.

18. The radio communication apparatus according to claim 11,
wherein the processes comprise executing operations after completion of receiving a payload signal.

19. A radio communication apparatus, comprising:
at least one interface connected to an external instrument;
a processor to execute a program; and
a memory to store the program which, when executed by the processor, performs processes of:
performing radio communication with an external radio communication device;
receiving a received field strength of a preamble signal received from the external radio communication device;
deactivating an operation of an interface whose amount of receiving sensitivity degradation is largest, based on a received field strength class determined according to the received field strength, the amount of receiving sensitivity degradation being an amount of degradation in a receiving sensitivity, the degradation being caused by the operation of the interface, the interface being included in the at least one interface being activated.

20. The radio communication apparatus according to claim 19,
wherein before the radio communication apparatus is operated, the processes comprise:
measuring a measurement receiving sensitivity value indicating a receiving sensitivity at a varying radio frequency when the at least one interface is activated; and
calculating the amount of receiving sensitivity degradation based on a difference between the measurement receiving sensitivity value measured and a receiving sensitivity actual value indicating a receiving sensitivity corresponding to the radio frequency when the at least one interface is not activated.

21. The radio communication apparatus according to claim 19,
wherein the processes comprise executing operations after completion of receiving a payload signal.
